(19) United States
(12) Patent Application Publication
(10) Pub. No.: US 2013/0042718 A1
(43) Pub. Date: Feb. 21, 2013

(54) CONFORMABLE SHAPE MEMORY ARTICLE

(71) Applicants: Alan L. Browne, Grosse Pointe, MI (US); Nancy L. Johnson, Northville, MI (US); Nilesh D. Mankame, Ann Arbor, MI (US); Robin Stevenson, Bloomfield, MI (US)

(72) Inventors: Alan L. Browne, Grosse Pointe, MI (US); Nancy L. Johnson, Northville, MI (US); Nilesh D. Mankame, Ann Arbor, MI (US); Robin Stevenson, Bloomfield, MI (US)

(73) Assignee: GM GLOBAL TECHNOLOGY OPERATIONS LLC, Detroit, MI (US)

(21) Appl. No.: 13/210,015

(22) Filed: Aug. 15, 2011

(51) Int. Cl. G05G 5/06; C22F 1/00; B32B 5/16; B32B 15/04

(52) U.S. Cl. 74/527; 148/402; 148/563; 428/323

(57) ABSTRACT

A conformable shape memory article comprises a deformable enclosure covering and discrete particles disposed within the enclosure covering, wherein the discrete particles comprise a shape memory polymer, or the discrete particles have a hollow shell structure comprising a shape memory alloy. In a more specific embodiment, the enclosure is elastically deformable.

### FIELD OF THE INVENTION

Exemplary embodiments of the invention are related to shape memory articles and, more specifically, to articles containing shape memory particles or granules.

### BACKGROUND

Shape memory articles have been used and proposed for use in a wide variety of applications, including but not limited to furniture, receptacles, retention devices, medical devices. Such articles often are fabricated from or contain a layer or component comprising a shape memory polymer (SMP) or a shape memory alloy (SMA). In many cases, it is desirable for the shape memory article to utilize its shape memory capability to conform its shape to that of another object or article. This effect can only be achieved with difficulty using shape memory alloys because the shape memory alloy can usually only be trained to remember one or perhaps two geometries or dimensions. Conformability of an article can be achieved using a shape memory alloy component or components to urge an elastically deformable component into a conforming relationship with a target object or article; however, such articles are limited in their ability to conform to a wide variety of shapes, and also require relatively complex designs using multiple components with different functions.

Shape memory polymers, including shape memory polymer foams, have been used to make conforming shape memory articles where the SMP is heated to a low-modulus state, deformed, and then cooled to a high-modulus state to ‘lock in’ the deformation. However, such articles must start from a pre-determined molded shape, and are limited in the degree of deformation away from this pre-determined shape that the article may achieve. And, even in applications where the same general shape of the article is to be maintained even after deformation, the shape memory performance of the polymer may be limited if the SMP deformation is concentrated at the surface where it comes into contact with the object or article to which it is to be conformed.

In view of the above, many alternatives have been used over the years; however, new and different alternatives are always well received that might be more appropriate for or function better in certain environments or could be less costly or more durable.

### SUMMARY OF THE INVENTION

In one exemplary embodiment, a conformable shape memory article comprises a deformable enclosure covering and discrete particles disposed within the enclosure covering, wherein the discrete particles comprise a shape memory polymer, or the discrete particles have a hollow shell structure comprising a shape memory alloy. In a more specific embodiment, the enclosure is elastically deformable.

In another exemplary embodiment, a lockable rotational device comprises a cylindrical housing and a cylindrical shaft disposed within the cylindrical housing, the shaft and housing being rotationally movable with respect to each other and defining an annular space between the shaft and the housing. The device further includes discrete particles disposed in the annular space or protuberances on the outer surface of the shaft or on the inner surface of the housing, the discrete particles or protuberances comprising a shape memory polymer or having a hollow shell structure comprising a shape memory alloy.

The above features and advantages, and other features and advantages of the invention are readily apparent from the following detailed description of the invention when taken in connection with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIGS. 1A-1C depict a cross-sectional schematic diagram of an exemplary conformable bi-stable article before, during, and after having its shape conformed to another article;

FIG. 2 depicts a hollow shell SMA particle;

FIG. 3 depicts a hollow shell SMA particle formed from SMA lattice elements;

FIG. 4 depicts a lockable rotational device having shape memory particles in an annular space; and

FIG. 5 depicts a lockable rotational device having shape memory protuberances on one or more of the rotational components.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

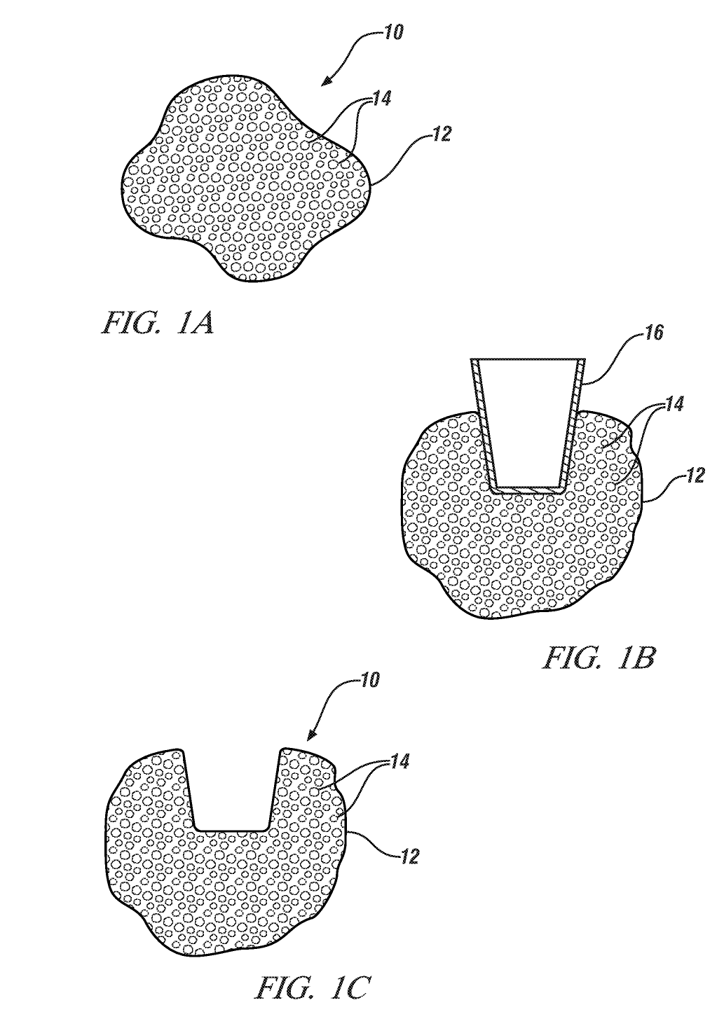

Turning now to the Figures, FIGS. 1A-1C depict an exemplary embodiment of shape memory article as described herein along with an exemplary operation of the article. FIG. 1A shows a cross-section view of a shape memory article 10 comprising an elastically deformable enclosure covering 12 having therein a plurality of discrete particles 14. The deformable enclosure covering may be made of any readily, including elastically, deformable material, including vinyl polymers, polyurethane, silicone rubber, thin metal foils, fabrics. In one exemplary embodiment, the enclosure covering comprises a shape memory polymer. The discrete particles can comprise a shape memory polymer or can have a hollow shell structure comprising a shape memory alloy, or the particles can have a hollow shell structure comprising both a shape memory polymer and a shape memory alloy. The general nature of the operation of the article in FIG. 1A is that the covering and the particles therein are configured so that the article is not readily deformable at a first temperature and is more readily deformable at a second temperature. The article may be maintained in its unformed shape as shown in FIG. 1A (or a previous formed shape) until it is desired to form the article to a new shape, at which time the temperature is changed to reduce the modulus of the discrete particles, thereby rendering the article more readily deformable. In the case of SMP this involves an increase in temperature, in the case of SMA a decrease in temperature. The deformable article may then be formed to a new shape as shown in FIG. 1B, which depicts a drink cup 16 pressed against the exterior of the covering 12 to cause it to deform into a cavity shape matching the shape of the cup. Discrete particles 14, which are now at a temperature to provide a low modulus so they can be more readily formed, are deformed by the external pressure being applied by the drink cup against the covering, and the article thereby deforms to match the shape of the cup. The temperature is then changed to increase the modulus of the particles 14, making the article more difficult to deform so that it retains the shape imparted in FIG. 1B. The article 10 with this retained shape is shown in FIG. 1C.

In one exemplary embodiment, the discrete particles comprise a shape memory polymer. Shape memory particles as utilized herein can be solid or hollow, and if they are hollow, they may include an opening to release internal pressure when the particle is deformed. “Shape memory polymer” or “SMP” generally refers to a polymeric material, which exhibits a change in a property, such as an elastic modulus, a shape, a dimension, a shape orientation, or a combination comprising at least one of the foregoing properties upon application of an activation signal. Shape memory polymers may be thermoresponsive (i.e., the change in the property is caused by a thermal activation signal), photoresponsive (i.e., the change in the property is caused by a light-based activation signal), moisture-responsive (i.e., the change in the property is caused by a liquid activation signal such as humidity, water vapor, or water), or a combination comprising at least one of the foregoing.

Generally, SMPs are phase segregated co-polymers comprising at least two different units, which may be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment may be crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n−1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be imparted a permanent shape. A permanent shape for the SMP can be set or memorized by subsequently cooling the SMP below that temperature. As used herein, the terms “original shape”, “previously defined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment while maintaining the deforming external stress or load.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it may be possible to demonstrate multiple permanent shapes. Similarly using a layered or composite approach, a combination of multiple SMPs will demonstrate transitions between multiple temporary and permanent shapes.

For SMPs with only two segments, the temporary shape of the shape memory polymer is set at the first transition temperature, followed by cooling of the SMP, while under load, to lock in the temporary shape. The temporary shape is maintained as long as the SMP remains below the first transition temperature. The permanent shape is regained when the SMP is once again brought above the first transition temperature with the load removed. Repeating the heating, shaping, and cooling steps can repeatedly reset the temporary shape.

Most SMPs exhibit a “one-way” effect, wherein the SMP exhibits one permanent shape. Upon heating the shape memory polymer above a soft segment thermal transition temperature without a stress or load, the permanent shape is achieved and the shape will not revert back to the temporary shape without the use of outside forces.

As an alternative, some shape memory polymer compositions can be prepared to exhibit a “two-way” effect, wherein the SMP exhibits two permanent shapes. These systems include at least two polymer components. For example, one component could be a first cross-linked polymer while the other component is a different cross-linked polymer. The components are combined by layer techniques, or are interpenetrating networks, wherein the two polymer components are cross-linked but not to each other. By changing the temperature, the shape memory polymer changes its shape in the direction of a first permanent shape or a second permanent shape. Each of the permanent shapes belongs to one component of the SMP. The temperature dependence of the overall shape is caused by the fact that the mechanical properties of one component (“component A”) are almost independent of the temperature in the temperature interval of interest. The mechanical properties of the other component (“component B”) are temperature dependent in the temperature interval of interest. In one embodiment, component B becomes stronger at low temperatures compared to component A, while component A is stronger at high temperatures and determines the actual shape. A two-way memory device can be prepared by setting the permanent shape of component A (“first permanent shape”), deforming the device into the permanent shape of component B (“second permanent shape”), and fixing the permanent shape of component B while applying a stress.

It should be recognized by one of ordinary skill in the art that it is possible to configure SMPs in many different forms and shapes. Engineering the composition and structure of the polymer itself can allow for the choice of a particular temperature for a desired application. For example, depending on the particular application, the last transition temperature may be about 0° C. to about 300° C. or above. A temperature for shape recovery (i.e., a soft segment thermal transition temperature) may be greater than or equal to about −30° C. Another temperature for shape recovery may be greater than or equal to about 40° C. Another temperature for shape recovery may be greater than or equal to about 100° C. Another temperature for shape recovery may be less than or equal to about 250° C. Yet another temperature for shape recovery may be less than or equal to about 200° C. Finally, another temperature for shape recovery may be less than or equal to about 150° C.

Optionally, the SMP can be selected to provide stress-induced yielding, which may be used directly (i.e. without heating the SMP above its thermal transition temperature to ‘soften’ it) to make the pad conform to a given surface. The maximum strain that the SMP can withstand in this case can, in some embodiments, be comparable to the case when the SMP is deformed above its thermal transition temperature.

Although reference has been, and will further be, made to thermoresponsive SMPs, those skilled in the art in view of this disclosure will recognize that photoresponsive SMP's, moisture-responsive SMPs and SMPs activated by other methods may readily be used in addition to or substituted in place of thermoresponsive SMPs. For example, instead of using heat, a temporary shape may be set in a photoresponsive SMP by irradiating the photoresponsive SMP with light of a specific wavelength (while under load) effective to form specific crosslinks and then discontinuing the irradiation while still under load. To return to the original shape, the photoresponsive SMP may be irradiated with light of the same or a different specific wavelength (with the load removed) effective to cleave the specific crosslinks. Similarly, a temporary shape can be set in a moisture-responsive SMP by exposing specific functional groups or moieties to moisture (e.g., humidity, water, water vapor, or the like) effective to absorb a specific amount of moisture, applying a load or stress to the moisture-responsive SMP, and then removing the specific amount of moisture while still under load. To return to the original shape, the moisture-responsive SMP may be exposed to moisture (with the load removed).

Suitable shape memory polymers, regardless of the particular type of SMP, can be thermoplastics, thermosets-thermoplastic copolymers, interpenetrating networks, semi-interpenetrating networks, or mixed networks. The SMP “units” or “segments” can be a single polymer or a blend of polymers. The polymers can be linear or branched elastomers with side chains or dendritic structural elements. Suitable polymer components to form a shape memory polymer include, but are not limited to, polyphosphazenes, poly(vinyl alcohols), polyamides, polyimides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecylacrylate). Examples of other suitable polymers include polystyrene, polypropylene, polyvinyl phenol, polyvinylpyrrolidone, chlorinated polybutylene, poly(octadecyl vinyl ether), poly (ethylene vinyl acetate), polyethylene, poly(ethylene oxide)-poly(ethylene terephthalate), polyethylene/nylon (graft copolymer), polycaprolactones-polyamide (block copolymer), poly(caprolactone) diniethacrylate-n-butyl acrylate, poly(norbornyl-polyhedral oligomeric silsequioxane), polyvinylchloride, urethane/butadiene copolymers, polyurethane-containing block copolymers, styrene-butadiene block copolymers, and the like. The polymer(s) used to form the various segments in the SMPs described above are either commercially available or can be synthesized using routine chemistry. Those of skill in the art can readily prepare the polymers using known chemistry and processing techniques without undue experimentation.

As will be appreciated by those skilled in the art, conducting polymerization of different segments using a blowing agent can form a shape memory polymer foam, for example, as may be desired for some applications. The blowing agent can be of the decomposition type (evolves a gas upon chemical decomposition) or an evaporation type (which vaporizes without chemical reaction). Exemplary blowing agents of the decomposition type include, but are not intended to be limited to, sodium bicarbonate, azide compounds, ammonium carbonate, ammonium nitrite, light metals which evolve hydrogen upon reaction with water, azodicarbonamide, N,N′ dinitrosopentamethylenetetramine, and the like. Exemplary blowing agents of the evaporation type include, but are not intended to be limited to, trichloromonofluoromethane, trichlorotrifluoroethane, methylene chloride, compressed nitrogen, and the like.

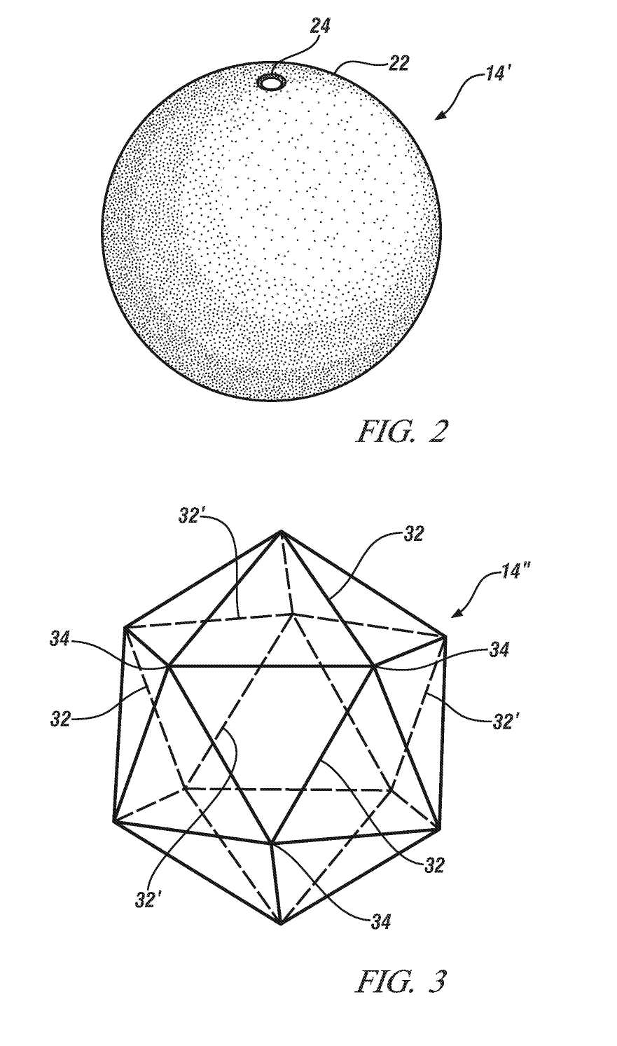

In another exemplary embodiment, the discrete particles have a hollow shell structure comprising a shape memory alloy (“SMA”). Compared to SMP particles, SMA particles can provide larger biasing forces for return toward their memorized shapes. FIG. 2 depicts an enlarged perspective view of a hollow shell SMA structure 14′. In the exemplary embodiment depicted in FIG. 2, a hollow shell wall 22 is made of shape memory alloy. Such hollow shell structures may include an optional opening, shown as opening 24 in FIG. 2 to relieve internal pressure from the shell during deformation. In another exemplary embodiment as shown in enlarged detail in FIG. 3, a hollow shell SMA structure 14″ is formed from an open lattice structure comprising shape memory alloy segments 32 and 32′ linked together at interconnecting links 34. For ease of illustration, the front-side segments 32 are shown as solid segments and the back-side segments 32′ are shown as having breaks where they cross behind (from the perspective of the viewer of the figure) front-side segments 32, although in actuality all of the segments are of course solid. In yet another exemplary embodiment, some of the segments 32 and 32′ and interconnecting links 34 may be formed from an SMA while other of the 32 and 32′ and interconnecting links 34 may be formed from an SMP.

Shape memory alloys are well-known in the art. Shape memory alloys are alloy compositions with at least two different temperature-dependent phases. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as the austenite start temperature (Aₛ). The temperature at which this phenomenon is complete is called the austenite finish temperature (A_{f}). When the shape memory alloy is in the austenite phase and is cooled, it begins to change into the martensite phase, and the temperature at which this phenomenon starts is referred to as the martensite start temperature (Mₛ). The temperature at which austenite finishes transforming to martensite is called the martensite finish temperature (M_{f}). It should be noted that the above-mentioned transition temperatures are functions of the stress experienced by the SMA sample. Specifically, these temperatures increase with increasing stress. In view of the foregoing properties, deformation of the shape memory alloy is preferably at or below the austenite transition temperature (at or below Aₛ). Subsequent heating above the austenite transition temperature causes the deformed shape memory material sample to revert back to its permanent shape. Thus, a suitable activation signal for use with shape memory alloys is a thermal activation signal having a magnitude that is sufficient to cause transformations between the martensite and austenite phases.

The temperature at which the shape memory alloy remembers its high temperature form when heated can be adjusted by slight changes in the composition of the alloy and through thermo-mechanical processing. In nickel-titanium shape memory alloys, for example, it can be changed from above about 100° C. to below about −100° C. The shape recovery process can occur over a range of just a few degrees or exhibit a more gradual recovery. The start or finish of the transformation can be controlled to within a degree or two depending on the desired application and alloy composition. The mechanical properties of the shape memory alloy vary greatly over the temperature range spanning their transformation, typically providing shape memory effect, superelastic effect, and high damping capacity. For example, in the martensite phase a lower elastic modulus than in the austenite phase is observed. Shape memory alloys in the martensite phase can undergo large deformations by realigning the crystal structure arrangement with the applied stress, e.g., pressure from a matching pressure foot. The material will retain this shape after the stress is removed.

Suitable shape memory alloy materials for fabricating the conformable shape memory article(s) described herein include, but are not intended to be limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order. Selection of a suitable shape memory alloy composition depends on the temperature range where the component will operate.

The specifics of the operation of shape memory articles such as the one depicted in FIGS. 1A-1C will depend to a certain extent on the type of discrete particles inside the enclosure covering. In the case of SMP particles, the article is normally maintained at a temperature at which the SMP is in its high modulus state. When it is desired to modify the shape of the article, the article (or portions thereof) is heated to a temperature sufficient to reduce the modulus of the SMP particles so they can be more readily deformed. Then, after the shape of the article has been modified, the temperature is reduced to increase the modulus of the SMP particles so that the article retains its newly-modified shape until the article is heated back up again, at which time a new shape can be imparted.

In an exemplary embodiment where the discrete particles are SMA hollow shell particles, the SMA may be chosen that is in its low-modulus martensitic state at normal room temperature. The SMA particles can have a memorized shape in the austenitic state that is the particles' non-deformed shape. At normal room temperature in the martensitic state, the article may be subjected to shape modification such as shown in FIG. 1B, during which a number of the SMA particles will be deformed. Then, while the modified shape is maintained (e.g., by keeping the cup 16 from FIG. 1B in place), the article is heated so that the SMA undergoes a phase change to its austenitic state so that the SMA particles are caused to recover, at least partially, their memorized non-deformed shape. This shape recovery of the particles will cause them to push the enclosure covering snugly against the cup. Then, still maintaining the modified shape (e.g., by keeping the cup 16 from FIG. 1B in place), the article is cooled to cause the SMA to revert to the martensitic phase and remove the driving force of particles trying to recover their austenitic memorized shape, so that when the cup is removed, the article will retain this newly-modified shape until it is subjected to further deformation.

In other exemplary embodiments, hollow shell lattice discrete particles may be formed from both SMP and SMA segments and/or interconnects to provide unique properties. For example, if martensitic SMA particles are too easily deformed, SMP segments and/or interconnects having an actuation temperature (i.e., temperature at which transition between low modulus and high modulus states occurs) lower than that of the SMA can be incorporated into the lattice structure. In its low temperature high modulus state, the SMP can provide enhanced rigidity to the particles to prevent unwanted or unintended deformation. Then, when it is desired to modify shape, the particles can be heated above the SMP actuation temperature, lowering the SMP modulus and allowing the low modulus martensitic SMA segments and/or interconnects to be deformed. After deformation, further heating will cause the SMA transition to the austenitic phase and seek to return to its original shape so that the article will press snugly against whatever object the shape memory article is conformed to. Then, while maintaining the conformed shape, the shape memory article is cooled to below the SMP actuation temperature to lock in the newly modified shape.

In an alternative exemplary embodiment, a hollow shell lattice structure particle has both SMP and SMA segments and/or interconnects where the SMA is maintained in its austenitic state at room temperature, and also has super-elastic properties so that it undergoes a stress-induced phase conversion to the martensitic state when it is subjected to strain. In this exemplary embodiment, the particles are heated to reduce the modulus when shape change is desired, and the article is then subjected to shape modification, followed by cooling while the modified shape is maintained to lock in the newly modified shape. Up to that point, this exemplary embodiment functions similarly to the pure SMP particle embodiment. In this exemplary embodiment, subsequent heating without imposition of a modified shape will cause the super-elastic SMA to return to its starting shape much more forcefully than SMP alone. This is because the SMP alone would tend to relax its shape upon heating without the imposition of a modified shape, but would not actively return to its starting shape like the super-elastic SMA.

A number of variations may be implemented with the shape memory articles described herein. Some of these variations may be targeted towards providing a proper balance of mobility of the particles so that the article may be readily re-shaped when desired, versus immobility of the particles so that the article will retain any newly-modified shape as long as desired. In one exemplary embodiment, the enclosure also includes a fluid (either gaseous or liquid), which may be under pressure (e.g., higher than atmospheric pressure) to increase particle mobility. In another exemplary embodiment, the particles may have a shape (e.g., a star or other contorted shape) designed to interfere with other particles in order to decrease particle mobility. The quantity of shape memory particles within the enclosure will also of course impact the particles' mobility. The enclosure may also include non-shape memory particles in addition to shape memory particles.

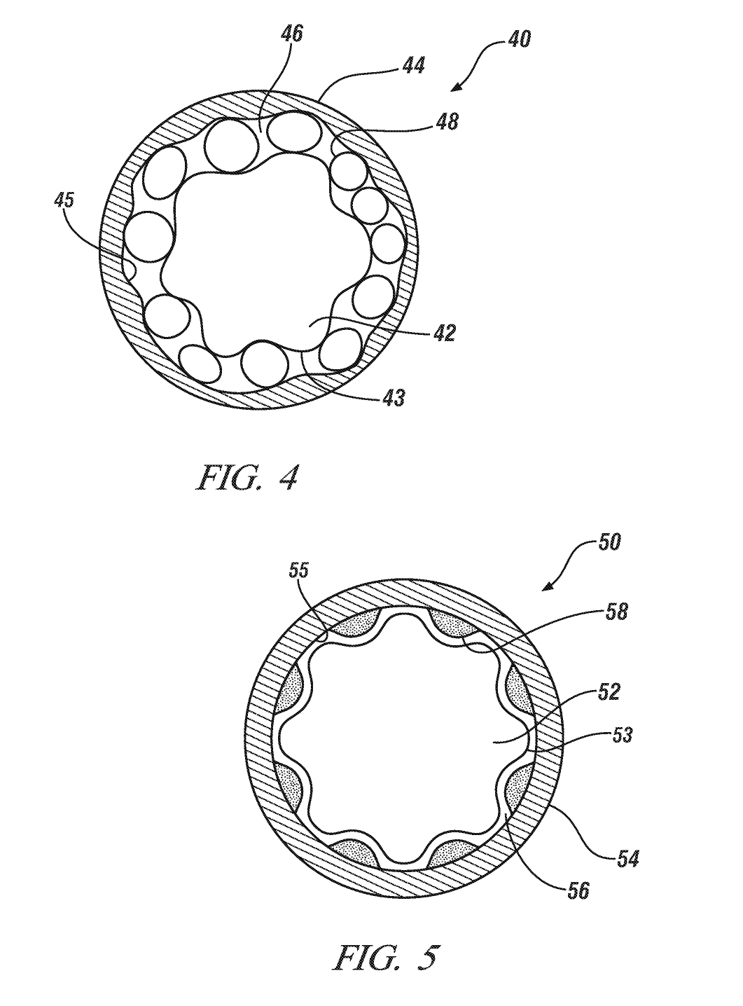

In another exemplary embodiment, the above-described SMP particles or hollow shell SMA particles may be utilized in exemplary embodiments of a lockable rotational device. One such exemplary embodiment is illustrated in FIG. 4, in which lockable rotatable device 40 has a cylindrical shaft 42 disposed in cylindrical housing 44, defining an annular space 46 between the shaft and the housing. Discrete particles 48 are disposed in the annular space. These particles may comprise an SMP or may have a hollow shell structure comprising a shape memory alloy, as described above. The inner surface 45 of the housing 44 and/or the outer surface 43 of the shaft 42 may be uneven (e.g., peaks and valleys) in order to cause interference with the particles when they are in a non-deformed state. As with the shape memory article, the annular space 46 may contain a fluid to decrease resistance to movement of the particles 48, and/or the particles may be shaped to interfere with each other or with the surfaces 43,45 of the shaft 42 and the housing 44 in order to increase resistance. Non-shape memory particles may also be included in the annular space 46.

As an alternative embodiment, or in addition to discrete shape memory particles in the annular space of a rotatable device, shape memory protuberances may be utilized instead of or in addition to the particles 48 shown in FIG. 4. These protuberances are similar in structure to the above-described particles, but are affixed to one of the surfaces of the annular space instead of being free particles. As shown in FIG. 5, a lockable rotatable device 50 has a cylindrical shaft 52 disposed in cylindrical housing 54, defining an annular space 56 between the shaft and the housing. Protuberances 58 are disposed on the inner surface 55 of housing 54. These protuberances may comprise an SMP or may have a hollow shell structure comprising a shape memory alloy, as described above. The outer surface 53 of the shaft 52 (or the inner surface 55 of the housing 54 if the protuberances are disposed on the outer surface of the shaft) may be uneven (e.g., peaks and valleys) in order to cause interference with the protuberances when they are in a non-deformed state. As with the shape memory article, the annular space 56 may contain a fluid to decrease resistance to rotation of the shaft in the housing, and/or the protuberances may be shaped to increase the level of interference with opposing surface on the other side of the annular space. Shape memory particles and/or non-shape memory particles may also be included in the annular space 56.

As with the above-described shape memory articles, the operation of the lockable rotatable device depends on the type of particles or protuberances disposed in the annular space. In the case of SMP particles and/or protuberances, when rotation of the device is not desired (i.e., a locked state), it is maintained at a temperature at which the SMP is in its high modulus state. The relatively rigid shape of the particles and/or protuberances will interfere with each other and with the surfaces of shaft and/or housing to prevent rotation of the device. When rotation is desired, the device (or at least the annular space in the device) is heated to a temperature sufficient to reduce the modulus of the SMP particles and/or protuberances so they can be more readily deformed, thereby allowing for rotation of the device. When it is desired to again prevent rotation, the temperature is reduced to increase the modulus of the SMP particles and/or protuberances until such time as rotation is desired again, at which time it may be heated back up again.

In the case of hollow shell SMA particles or protuberances, when rotation is desired, the temperature of the device (or at least the annular space in the device) is maintained at a low enough temperature so that the SMA is in its low-modulus martensitic state, allowing for deformation of the particles and/or protuberances so that the device can rotate. Rotation can be prevented by heating the device or annular space of the device to a temperature sufficient to cause a phase change of the SMA to the austenitic phase, causing the particles and/or protuberances to return to their original shape, thus preventing rotation. An elevated temperature can be maintained for a full lock-out against further rotation, or the temperature can be reduced so the SMA transitions back to the martensitic state. In this martensitic state while the device is at rest, the particles and/or protuberances may provide some resistance against further rotation. If a full lock-out state is desired, SMP segments and/or linkages having an actuation temperature below that of the SMA may be incorporated into an SMA hollow shell structure at normal room temperature as described above, in which case the device will have to be heated above the SMP actuation temperature in order to unlock it and allow rotation.

The articles of the exemplary embodiments described herein may be used in various applications, including but not limited to hand controls like shifting levers or virtually any hand-held device like a cell phone where it may be desired to conform the device to an operator's hand, retention devices and holders including but not limited to cup holders or device holsters.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application. The terms “front”, “back”, “bottom”, “top”, “first”, “second”, “third” are used herein merely for convenience of description, and are not limited to any one position or spatial orientation or priority or order of occurrence, unless otherwise noted.

1. A conformable shape memory article, comprising a deformable enclosure covering and discrete particles disposed within said enclosure covering, wherein the discrete particles comprise a shape memory polymer, or the discrete particles have a hollow shell structure comprising a shape memory alloy.

2. The article of claim 1, further comprising a fluid disposed within said enclosure.

3. The article according to claim 1, wherein the discrete particles comprise a shape memory polymer.

4. The article according to claim 1, wherein the enclosure covering is elastically deformable.

5. The article according to claim 1, wherein the enclosure covering comprises a shape memory polymer.

6. The article according to claim 5, wherein the discrete particles further comprise a non-shape memory material.

7. The article of claim 5, wherein the discrete particles comprise a shape memory polymer, and the article is configured such that the particles are maintained in fixed relationship to one another at a first temperature such that the article is not deformable at the first temperature, but is deformable at a second temperature higher than the first temperature.

8. The article of claim 1, wherein the discrete particles have a hollow shell structure comprising a shape memory alloy.

9. The article of claim 1, wherein the discrete particles are formed from a lattice structure comprising shape memory alloy segments.

10. The article of claim 9, wherein the lattice structure further comprises shape memory polymer segments.

11. A lockable rotational device, comprising
a cylindrical housing;
a cylindrical shaft disposed within the cylindrical housing, said shaft and housing being rotationally movable with respect to each other and defining an annular space between the shaft and the housing; and
discrete particles disposed in the annular space or protuberances on the outer surface of the shaft or on the inner surface of the housing, said discrete particles or protuberances comprising a shape memory polymer or having a hollow shell structure comprising a shape memory alloy.

12. The device of claim 11, wherein one of the outer surface of the shaft or the inner surface of the housing have said protuberances thereon.

13. The device of claim 11, wherein both of the housing and the shaft have said protuberances thereon.

14. The device of claim 11, comprising said discrete particles disposed in the annular space.

15. The device of claim 14, further comprising a fluid disposed within said annular space.

16. The device of claim 11, wherein the discrete particles or protuberances comprise a shape memory polymer.

17. The device of claim 11, wherein the discrete particles are formed from a lattice structure comprising shape memory alloy segments.

18. The device of claim 17, wherein the lattice structure further comprises shape memory polymer segments.

19. A method of using the article of claim 1, comprising deforming the article at a first temperature, and then changing the temperature to increase the modulus of the shape memory polymer or the shape memory alloy to make the article resistant to further deformation.

20. A method of using the device of claim 11, comprising rotating either or both of the shaft and the housing with respect to each other at a first temperature, and then changing the temperature to increase the modulus of the shape memory polymer or the shape memory alloy to make the device resistant to further rotation.
